(19) United States
(12) Patent Application Publication
(10) Pub. No.: US 2013/0019619 A1
(43) Pub. Date: Jan. 24, 2013

(54) BLADELESS MISTING FAN

(71) Applicants: Daniel W. Forbes, Boynton Beach, FL (US); Joseph D. Moskal, Miramar, FL (US); Kenneth Roach, Coral Springs, FL (US)

(72) Inventors: Daniel W. Forbes, Boynton Beach, FL (US); Joseph D. Moskal, Miramar, FL (US); Kenneth Roach, Coral Springs, FL (US)

(73) Assignee: ATICO INTERNATIONAL USA, INC., Fort Lauderdale, FL (US)

(21) Appl. No.: 13/554,804

(22) Filed: Jul. 20, 2012

Related U.S. Application Data
(60) Provisional application No. 61/510,838, filed on Jul. 22, 2011.

(51) Int. Cl. B01F 3/04; F28C 3/08; F25D 17/06

(52) U.S. Cl. 62/91; 261/28

(57) ABSTRACT

The present invention relates generally to portable cooling devices. More specifically, the present invention relates to compact, portable bladeless fans featuring water misting capabilities for improved cooling functionality.

The present application claims priority to U.S. Provisional Patent Application Ser. No. 61/510,838, filed Jul. 22, 2011, the disclosure of which is herein incorporated by reference in its entirety,

### FIELD OF THE INVENTION

The present invention relates generally to portable cooling devices. More specifically, the present, invention relates to compact, portable bladeless fans featuring water misting capabilities for improved cooling functionality.

### BACKGROUND OF THE INVENTION

Compact, portable cooling devices such as handheld water misting fans exist. Such devices operate by combining a fine mist or spray of a liquid with an air stream that serves to both distribute the liquid droplets and accelerate the evaporation of the liquid from a user's skin and/or clothing. The combination of the cooling effects of the evaporation of the liquid into the surrounding air and the blowing of the air stream provides an enhanced cooling effect for the user of the device. Examples of such handheld misting fans can be found in U.S. Pat. No. 5,338,495 to Steiner et al., U.S. Pat. Nos. 5,667,732 and 5,837,167 to Lederer, and U.S. Pat. Nos. 5,667,731, 5,843,344, 5,965,067, 6,398,132, and 7,806,388 to Junkel et al., the disclosures of which are hereby incorporated by reference in their entireties.

These portable misting fans feature traditional fan mechanisms that use a series of blades that rotate about an axis. One disadvantage of a traditional bladed fan mechanism is that the rapidly rotating blades present a safety issue if an object or body part comes in contact with them. Another disadvantage of a traditional bladed fan mechanism is that the forward flow of air current produced by the rotating blades of the fan is not felt uniformly by the user, due to variations across the blade surface or across the outward facing surface of the fan. A third disadvantage of a traditional bladed fan mechanism is that such mechanisms tend to be noisy, due to the sound of the fan blades moving through the air.

Embodiments of the present invention provide novel, portable, bladeless misting fans that overcome the disadvantages of the bladed portable misting fans of the prior art.

### SUMMARY OF THE INVENTION

The present invention relates generally to portable cooling devices. More specifically, the present invention relates to compact, portable bladeless fans featuring water misting capabilities for improved cooling functionality.

In some embodiments, provided herein is a portable bladeless misting fan assembly comprising: a base; a bladeless air nozzle mounted on the base; a component for creating an air flow through the nozzle; a liquid reservoir (e.g., for holding a water supply); and a misting nozzle connected to said liquid reservoir. In some embodiments, the liquid reservoir is contained within the base. In some embodiments, the air nozzle is circular in shape.

In some embodiments, the fan assembly comprising a handle configured for gripping by a human hand. In some embodiments, the fan assembly comprises an actuator for initiating a misting action from the misting nozzle. In some embodiments, misting is continuous or controlled by a timer.

The present invention further provides methods for cooling objects (e.g., humans or other animals). In some embodiments, the methods comprise using a fan assembly as described in any of the embodiments described herein and passing air and mist from the fan onto an object to be cooled,

### DESCRIPTION OF THE FIGURES

FIG. 1 shows a left side cross-sectional view of an embodiment of the invention.

FIG. 2 shows a left side elevational view of an embodiment of the invention, the left and right, side elevational views being mirror images.

FIG. 3 shows a front perspective view of an embodiment of the invention.

FIG. 4 shows a rear perspective view of an embodiment of the invention.

FIG. 5 shows a front elevational view of an embodiment of the invention.

FIG. 6 shows a rear elevational view of an embodiment of the invention,

FIG. 7 shows a top plan view of an embodiment of the invention.

FIG. 8 shows a bottom plan view of an embodiment of the invention.

### DETAILED DESCRIPTION OF THE INVENTION

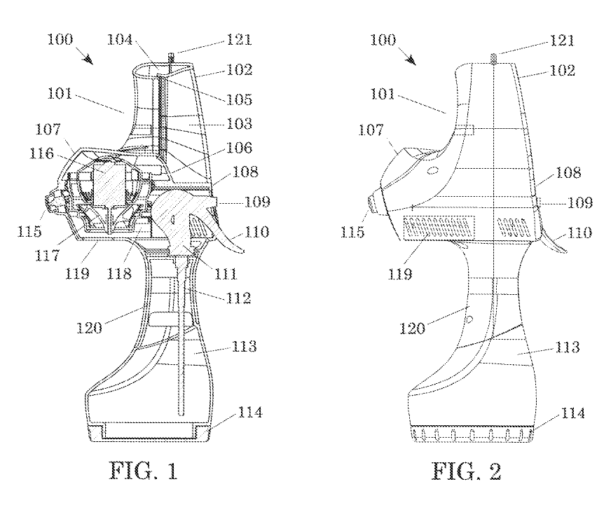

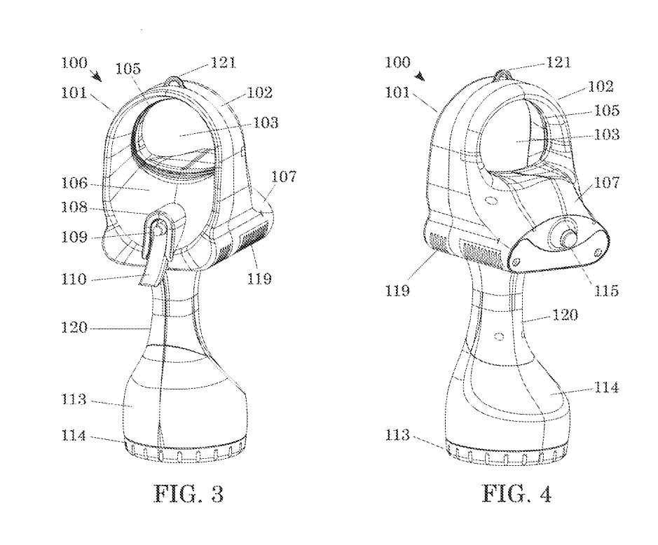

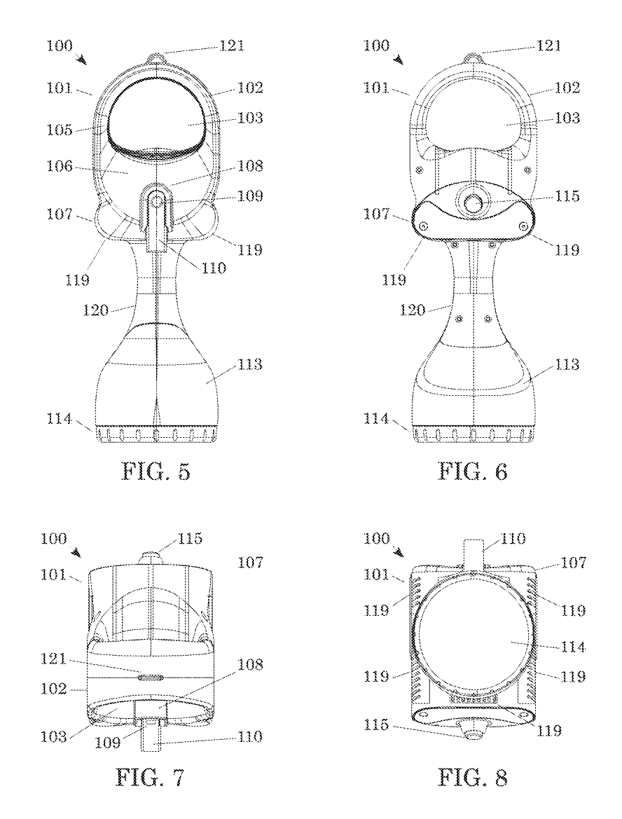

FIGS. 1-8 show a bladeless misting fan 100 in one embodiment of the present invention. In a preferred embodiment, the bladeless misting fan 100 has a housing 101 comprising an annular air nozzle 102 for directing an air stream. The air nozzle 102 defines a central opening 103 through which an air stream is directed. The air nozzle 102 comprises an interior passage 104 into which an air stream produced by a fan mechanism is received, and a mouth 105 through which the air stream is emitted. A rear surface 106 adjacent to the air nozzle 102 is shaped to direct the air stream through the central opening 103.

The housing 101 has a base portion 107 housing the mechanical and operational components of the bladeless misting fan 100. The front of the base portion 107 comprises a misting nozzle housing 108 comprising a misting nozzle 109 and a trigger 110 for actuating a misting mechanism to direct a flow of atomized liquid through the misting nozzle 109, The misting mechanism comprises a means of drawing a liquid (e.g., water) from a liquid reservoir 113 to the misting nozzle 109, such as a trigger-actuated spray pump 111 that draws liquid from the liquid reservoir 113 to the misting nozzle 109 via a tube 112. The liquid reservoir 113 has an end cap 114 that is removable to allow the reservoir to be filled with a suitable liquid. In some embodiments, the liquid reservoir 113 and the opening covered by the end cap 114 are sized to allow frozen liquids (e.g., ice cubes) to be placed within the liquid reservoir.

The rear of the base portion 107 comprises a button 115 for actuating a fan mechanism. The fan mechanism is enclosed within the base portion 107, and includes a means for producing a controlled air stream, as well as a suitable power source. The means for producing a controlled air stream may comprise an electric motor 116 that drives a turbine 117. The base portion 107 may comprise a battery compartment 118 housing one or more batteries that serve as a power source for the motor 116.

The controlled air stream is produced by using the rotational force of the turbine 117 to draw air into the base portion 107 through, for example, one or more vents 119, direct the air stream into the interior passage 104, and emit the air stream from the mouth 105 of the air nozzle 102. The emitted air stream provides a cooling effect for persons, animals, objects, or ambient air in the path of the air stream. The simultaneous operation of the fan mechanism and the misting mechanism results in wider dispersion of the flow of liquid via the controlled air stream, which provides an enhanced cooling effect.

The housing 101 further comprises a handle portion 120 connecting the base portion 107 and the liquid reservoir 113, The handle portion 120 encloses the tube 112 connecting the liquid reservoir to the misting means. In some embodiments, the handle portion may contain at least a portion of the misting mechanism, the fan mechanism, and/or the power source for the fan mechanism (e.g., batteries).

The housing 101 may comprise a loop 121 for attaching a carrying strap. In some embodiments, the loop 121 is located at the top of the air nozzle 102. In other embodiments, the loop 121 may be located at a different portion of the bladeless misting fan 100, such as the handle portion 120 or the end cap 114. In preferred embodiments, the carrying strap is detachable. In yet other embodiments, the carrying strap is permanently attached.

The housing 101 may be fabricated from any suitable materials. In preferred embodiments, the material is both lightweight and durable, to aid in portability. In particularly preferred embodiments, the housing 101 is fabricated from a thermoformable material such as plastic. In other embodiments, the housing 505 is fabricated from metal or glass. In yet other embodiments, the housing 101 is fabricated from a combination of materials.

The fan mechanism may comprise any suitable means of producing an air stream that is delivered via a bladeless air nozzle. Suitable fan mechanisms are disclosed, for example, in U.S. Pat. No. 2,488,467 to De Lisio and U.S. Pat. No. 7,931,449 to Fitton et al., the disclosures of which are hereby incorporated by reference in their entireties In preferred embodiments of the present invention, the fan mechanism is powered by a small electric motor of conventional design. In particularly preferred embodiments, the fan mechanism is battery powered. Examples of battery powered electric motors used to power fan mechanisms are disclosed in U.S. Pat. No. 5,338,495 to Steiner et al., U.S. Pat. Nos. 5,667,732 and 5,837,167 to Lederer, and U.S. Pat. Nos. 5,667,731, 5,843,344, 5,965,067, 6,398,132, and 7,806,388 to Junkel et al., the disclosures of which are hereby incorporated by reference in their entireties

The misting mechanism may comprise any suitable means of drawing a liquid from a liquid reservoir 113 to one or more misting nozzles 109 to produce an atomized liquid spray, such as, for example, via a conventional trigger-actuated spray pump mechanism 111. Suitable spray pump mechanisms are disclosed, for example, in U.S. Pat. No. 5,338,495 to Steiner et al., U.S. Pat. Nos. 5,667,732 and 5,837,167 to Lederer, and U.S. Pat. Nos. 5,667,731, 5,843,344, 5,965,067, 6,398,132, and 7,806,388 to Junkel et al., the disclosures of which are hereby incorporated by reference in their entireties.

In some embodiments, the misting mechanism comprises two misting nozzles. In other embodiments, the misting mechanism comprises three or more misting nozzles. In embodiments where two or more misting nozzles are used, the misting nozzles may be arrayed about the circumference of the air nozzle 102. For example, in embodiments using three misting nozzles, the nozzles may be located at approximately the twelve o'clock (0 degrees) position, the three o'clock (90 degrees) position, and the nine o'clock (270 degrees) position relative to the annular face of the air nozzle, although any suitable locations may be used for the misting nozzles. The two or more misting nozzles may be connected to the misting mechanism via one or more tubes. In some embodiments, each of the two or more misting nozzles is connected to the misting mechanism via a separate tube. In other embodiments, each of the two or more misting nozzles is connected to a separate misting mechanism and is capable of being independently operated by a user. Where a single tube is employed to deliver liquid to multiple misting nozzles, in some embodiments a circular tube is employed having holes located at each of the misting nozzle positions to allow delivery of liquid to each of the misting nozzles.

The flow rate of the one or more misting nozzles may be adjustable by a user (e.g., via a switch or dial operating a valve) to control the level of moisture produced by the one or more misting mechanisms. In embodiments where two or more misting nozzles are used, the flow rates of each misting nozzle may be independently adjustable by a user. In some embodiments where two or more misting nozzles are used, each of the misting nozzles is capable of being independently opened or closed completely.

In some embodiments, the one or more misting nozzles may be configured to direct a flow of liquid to the interior of the housing 101, such that the controlled air stream produced by the fan mechanism is combined with the flow of atomized liquid produced by the misting mechanism prior to being emitted through the mouth 105 of the air nozzle 102. Thus, in some embodiments, pre-moistened air is emitted from the mouth 505. In some such embodiments, a misting nozzle is positioned internally anywhere between an air intake component (e.g., a vent 119) and the air nozzle 102. In some embodiments, the housing 101 may comprise a draining means, such as an opening or drainage tube in communication with the liquid reservoir 113, to prevent liquid from collecting in the interior of the housing 101.

The housing 101 may be of any suitable dimensions. In preferred embodiments, the housing 101 is sufficiently compact to be capable of being held in a user's hand. In particularly preferred embodiments, the housing has a height of between 200 and 400 millimeters, a width of between 50 and 150 millimeters, and a depth of between 75 and 175 millimeters. In other embodiments, the housing has a height of between 275 and 325 millimeters, a width of between 75 and 125 millimeters, and a depth of between 100 and 150 millimeters, although other dimensions may be used.

The air nozzle 102 may be of any suitable size and shape. In preferred embodiments, the air nozzle 102 is generally circular in shape, and has a diameter of between 50 and 150 millimeters. In other embodiments, the air nozzle 102 is generally oval in shape. In yet other embodiments, the air nozzle is rectangular, triangular, or irregularly shaped.

From the above description of the invention, those skilled in the art will perceive improvements, changes, and modifications. Such improvements, changes, and modifications within the skill of the art are intended to be covered by the appended claims. All references, publications, and patents cited in the present application are herein incorporated by reference in their entireties.

We claim:

1. A portable bladeless misting fan assembly comprising: a base; a bladeless air nozzle mounted on said base; a component for creating an air flow through the nozzle; a liquid reservoir; and a misting nozzle connected to said liquid reservoir.

2. The fan assembly of claim 1, wherein said liquid reservoir is contained within said base.

3. The fan assembly of claim 1, wherein said air nozzle is circular in shape.

4. The fan assembly of claim 1, further comprising a handle configured for gripping by a human hand.

5. The fan assembly of claim 1, further comprising an actuator for initiating a misting action from said misting nozzle.

6. A method of cooling, comprising: providing the fan assembly of claim 1 and passing air and mist from said fan assembly onto an object.

7. The method of claim 6, wherein said object is a human.
